(19) United States
(12) Patent Application Publication
(10) Pub. No.: US 2005/0015742 A1
(43) Pub. Date: Jan. 20, 2005

(54) Methods and systems for facilitating data processing workflow

(76) Inventors: Eric Wood, Menlo Park, CA (US); Emil Tso, San Carlos, CA (US); Chinhao Lee, Mountain View, CA (US)

Correspondence Address: FINNEGAN, HENDERSON, FARABOW, GARRETT & DUNNER;LLP, 1300 I STREET, NW, WASHINGTON, DC, 20005, US

(21) Appl. No.: 10/848,118

(22) Filed: May 19, 2004

Related U.S. Application Data
(60) Provisional application No. 60/471,940, filed on May 19, 2003.

(51) Int. Cl. G06F 9/44; G06F 17/00

(52) U.S. Cl. 717/101; 715/501.1

(57) ABSTRACT

Systems and methods are disclosed for facilitating data processing workflow. The systems and methods may provide a first representation of data relevant to a first aspect of a participant's participation in an enterprise, receive input from the participant interacting with the data (the participant's interaction changing the first representation), conceal the first representation, provide a second representation of data, and subsequently provide the first representation including the changes from the participant's interaction. The first representation and the second representation may be provided in a portion of a portal workspace.

This application claims the benefit of priority from U.S. Provisional Application No. 60/471,940, entitled “Facilitating Workflow,” filed May 19, 2003, the disclosure of which is expressly incorporated herein.

### BACKGROUND

I. Technical Field

The present invention generally relates to data processing and computerized methods and systems. More particularly, the invention relates to methods and systems for facilitating data processing workflow.

II. Background Information

Portal systems combine disparate computer resources into an integrated interface. Users interact with the resources via user interface elements on portal pages, which may be rendered in web browser windows or screen displays. Portal systems allow an employee to view and interact with information and tools from a wide variety of sources, such as word processing programs, spreadsheet programs, databases, and other sources.

This interaction, denoted as the workflow of the data processing, is often the rate-limiting step of many data processing activities. For example, it may become necessary for an employee to work with many different resources to accomplish a particular task. However, switching from one resource to another, as well as locating the desired data, may require the employee to spend considerable time that is unproductive.

Portal computing systems can improve workflow by allowing workers to more easily access resources and information needed to perform their jobs. For example, role-based portal systems strive to improve workflow by providing user interfaces that allow a worker with a particular job role to access data and resources usually associated with the particular job role.

In view of the foregoing, there is a need for improved computing methods and systems, including methods and systems to facilitate data processing workflow. There is also a need for methods and systems to facilitate data processing workflow to allow, for example, employees to more efficiently perform their work and/or more effectively organize data.

### SUMMARY

Consistent with embodiments of the present invention, methods and systems are disclosed for facilitating workflow during data processing activities.

In accordance with one embodiment, a method is provided that comprises providing a first representation of data relevant to a first aspect of a participant's participation in an enterprise; receiving input from the participant interacting with the data (the participant's interaction changing the first representation); concealing the first representation; providing a second representation of data; and subsequently providing the first representation including the changes from the participant's interaction. Consistent with embodiments of the present invention, the first representation and the second representation may be provided in a portion of a portal workspace.

As disclosed herein, the second representation can represent data relevant to a second aspect of the participant's participation in the enterprise or data relevant to the first aspect of the participant's participation in the enterprise. The first aspect of the participant's participation in the enterprise can be a workset. Input can be received from the participant selecting the second aspect of the participant's participation in the enterprise.

In accordance with another embodiment, a method is provided that comprises providing a dense inventory of a collection of worksets to a participant in an enterprise, each workset including data relevant to an aspect of the participant's participation in the enterprise; receiving input from the participant selecting a first workset from the collection to be made active; receiving input from the participant selecting a second workset from the collection to be made active; and providing an expanded inventory including the first and second worksets. The first and second worksets can each be selectable from the expanded inventory to allow the participant to interact with the data relevant to that aspect of the participant's participation in the enterprise.

As disclosed herein, the dense inventory of the collection of worksets can be a vertical list of names of worksets in the collection. The expanded inventory can be a horizontal list of names of worksets in the collection. The expanded inventory can be provided on a same workspace as the dense inventory.

Methods consistent with embodiments of the present invention may also include receiving input from the participant, again selecting the first workset from the collection and adding a second selectable entry to the expanded inventory. The second selectable entry can also identify the first workset. A description of the expanded inventory can be stored to subsequently recreate the expanded inventory in a portion of a portal environment. The dense inventory of the collection of worksets can be an exhaustive list of the collection of worksets.

In accordance with still another embodiment, a system is provided that comprises a data object including an inventory of selected worksets. The worksets can be selected from a larger inventory of worksets based on a particular interaction by the participant with a portal environment during participation in the enterprise. The worksets can each include data relevant to a particular activity in the participant's participation in an enterprise.

These and other aspects can include a feature to allow, for example, the inventory of selected worksets to include two entries for a same single workset.

The described systems and techniques can also be implemented to realize one or more of the following advantages. An expanded inventory of active worksets can be represented in conjunction with a dense, more exhaustive, inventory of worksets. Because an employee is likely to need only a subset of the potential worksets at any one time, the user interface can be made compact and unnecessary navigation features can be excluded or confined to subsections of a display panel where their packing density is high. Such a high packing density allows a large number of worksets to be available to an individual, even if all worksets are not frequently active. Further, active workset tabs or other identifiers can be created as needed, increasing the navigability of the active workset identifiers.

Moreover, systems and techniques consistent with the invention may enable a representation of data relevant to a workset to maintain state memory. In other words, when an employee returns to a previously instantiated workset, the results of user interaction with the workset representation can be returned to the state in which it was left.

As another example of a potential advantage, users may be able to launch multiple instances of the same workset by launching them from the control center. The multiple instances can be multiply included in an inventory of active worksets, with different entries in the inventory providing direct navigation to different tasks in the same workset. The multiple entries can include an identification of the task. Such multiple entries with state memory can allow an employee to read information from one task of a workset and then switch to a previously instantiated task in the same workset without losing work.

In another embodiment, a system consistent with the present invention comprises a portal workspace, wherein a portion of the portal workspace includes a first representation of data relevant to a first aspect of a participant's participation in an enterprise; means for receiving input from the participant interacting with the data; means for changing the first representation based upon the participant's interaction; means for concealing the first representation; means for providing a second representation of data in the portion of the portal workspace; and means for providing, subsequently in the portion of the portal workspace, the first representation including the changes from the participant's interaction.

In another embodiment, a system consistent with the present invention comprises a dense inventory of a collection of worksets for a participant in an enterprise, wherein each workset includes data relevant to an aspect of the participant's participation in the enterprise; means for receiving input from the participant selecting a first workset from the collection to be made active; means for receiving input from the participant selecting a second workset from the collection to be made active; and means for providing an expanded inventory including the first and second worksets, wherein the first and second worksets are each selectable from the expanded inventory to allow the participant to interact with the data relevant to that aspect of the participant's participation in the enterprise.

Further, an inventory of active worksets, and their geometric arrangement in a workspace, can be saved and later recalled. After an employee interacts with the system, a custom set of active worksets optimized for the particular interaction may be assembled. By saving such an assemblage, including the tasks within the worksets and the geometric arrangement in the workspace, an employee is able to recall customized configurations at will.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary structure of a workset-based portal system, consistent with an embodiment of the invention;

FIG. 2 shows an exemplary portal page, consistent with an embodiment of the invention;

FIG. 3A is a flow chart showing an overview of an exemplary workflow for a workset-based portal system, consistent with an embodiment of the invention;

FIG. 3B is a flow chart showing an exemplary workflow for a workset-based portal system, consistent with another embodiment of the invention;

FIG. 4 shows an exemplary portal page after step 3200 of FIG. 3B;

FIG. 5 shows the portal page of FIG. 4 after step 3250 of FIG. 3B;

FIG. 6 shows the portal page of FIG. 2 after step 3350 of FIG. 3B;

FIG. 7 shows the portal page of FIG. 6 after step 3450 of FIG. 3B;

FIG. 8 shows another exemplary portal page after step 3600 of FIG. 3B;

FIG. 9 shows the portal page of FIG. 4 after step 3700 of FIG. 3B;

FIG. 10 shows another exemplary portal page, consistent with an embodiment of the invention, including an active workset inventory with additional information identifying tasks in the active worksets;

FIG. 11 shows another example of a portal page representing data regarding a control center workset;

FIG. 12 shows another example portal page after step 3200 of FIG. 3B;

FIG. 13 shows the portal page of FIG. 11 after step 3350 of FIG. 3B;

FIG. 14 shows the portal page of FIG. 11 after step 3450 of FIG. 3B;

FIG. 15 shows another example portal page after step 3600 of FIG. 3B; and

FIG. 16 shows the portal page of FIG. 11 after step 3700 of FIG. 3B.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Methods and systems consistent with the present invention facilitate and improve data processing workflow. Workflow refers to the tasks that an employee performs, as well as the manner in which the tasks are performed. For many employees, workflow includes accessing one or more application programs via the employee's computer, providing data for the one or more applications programs, and/or processing data. For example, a sales manager may access one or more competitor web sites using an Internet browser, view a display including product data such as price, and store and/or process competitor product data using another application program such as a spreadsheet program. Workflow is efficient when an employee can access needed data regarding information, executable applications, and resources quickly with minimal effort. Workflow is inefficient when an employee must spend time or complete complex series of actions to find or switch between data.

An employee's workset comprises data relating to an aspect of the employee's employment. The workset refers to data (e.g., one or more data objects) including content for achieving a particular work activity or small set of work activities. For example, when the work activity is to complete a budget, the workset may include machine-readable instructions for creating a budget spreadsheet program, the values of entries in the spreadsheet, graphical representations of the entries, additional information for use in changing, supplementing, or interpreting the entries, as well as the portal environment for presenting the data related to the activity to the employee.

Worksets can be further divided into tasks. Tasks comprise an item of portal content for achieving a particular goal, or a portion of a goal. Tasks may be associated with other tasks; for example, a first-level task may be associated with one or more second-level tasks, which may in turn be associated with third-level tasks.

Consistent with embodiments of the present invention, workset-based portal methods and systems may be provided to enable more efficient workflow. Workset-based portal systems may present an employee with workspaces that are targeted to the employee's specific work intents and/or dominant activities, rather than providing a comprehensive list of tasks for a particular job role. In a workset-based portal system, a workspace comprises a portal page or part of a portal page supporting a coherent set of tasks.

A workset-based portal system, consistent with embodiments of the invention, may be based on the recognition that an employee with a particular job role performs a number of different work roles, where each work role consists of a number of tasks directed at achieving a particular work goal. For example, a sales manager (job role) may perform various different work roles related to budgeting, team leading, key account management, promotion management, and market watching. Each of the work roles involves performing one or more tasks.

In order to enable an employee such as a sales manager to perform his work roles, and thus his job role, efficiently, a workset can be developed for each work role. In one embodiment, the workset includes the tasks and corresponding portal environment for performing the particular work role, which may be bundled into one manageable data object. Thus, the workset may reflect the employee's work intent rather than stereotypical job titles, standard business objects, or business processes.

In some implementations, each workset may define a complete working environment for a given work role using a hybrid collection of elements including tools, information, communication and collaboration features, and user interface requirements. These elements may include: a navigation structure; visual components such as views (e.g., “Iviews” or “integrated views” referring to a basic unit of portal content that can be used to display information or interact with the portal user) and pages; information and application services; work artifacts such as business objects, procedures, interest profiles, and subscription rules; and/or collaborative elements.

A workset may include data related to some or all of the following elements: communities (e.g., communities that associated users may want to participate in); context information (e.g., information about attributes associated with the workset, such as attributes that users associated with the workset typically would have); description (e.g., brief description of the work intent/work goal of the workset); information/resource collection (e.g., one or more bodies of information that associated users may use as resources for achieving the work goal); name (e.g., a human-understandable name for the workset); job roles (e.g., job roles typically associated with the workset; when a job role is assigned to a particular user, he may be associated with all worksets typically associated with the job role); subscriptions (e.g., a list of resource objects the employee may want to subscribe to); a navigation structure (e.g., the navigation structure provided by the workset, to be combined with other navigation structures including those provided by any other assigned worksets to produce a navigation structure for the particular workset-based portal user); taxonomies (e.g., particular classifications the employee may be interested in); and users (e.g., users associated with the workset; by including user data in a workset data object, notification tasks may be associated with the workset, and users associated with the workset may receive the notification).

Worksets can be an important source of context meta-data for personalization of an employee's portal environment. Each workset may have associated context meta-data such as a stereotypical profile for an employee assigned to the workset. The context data could include information such as skills, licenses, expertise, and education of a typical user to whom the workset is assigned. When the workset is assigned to an actual user, the associated context data may be assigned to his user profile. The context data may then be used to personalize the employee's portal environment. For example, particular content may be pushed to the employee as a result of the personalization. As mentioned above, one or more subscriptions and/or one or more memberships in a community may be activated based on context meta-data. By associating context data with particular worksets, the effort required to personalize portal environments for users may be significantly reduced.

Worksets may include state-less and/or state-full information or services. State-less content includes portal services and user interface elements. An example of a state-less service is a particular application that may be used to perform a task. For example, a state-less service may be a spreadsheet program for developing a budget. Worksets including state-less content may be used to deploy targeted services to portal users.

In contrast, a state-full service is one that represents the current state of a working process. For example, instantiated content (e.g., a particular instance of a spreadsheet program with a budget for a particular department on a particular date) is state-full rather than state-less. Examples of state-full content include: current artifacts that have been created (e.g., business objects, procedures, interest profiles, and subscription rules); folders and taxonomies that have been created, the current state of a workset (e.g., when a lifecycle is defined for the workset); a current collaborative network in terms of contacts and teams; and current team or project work.

Worksets including state-full content may be used to transfer a current work state from one user to another. For example, when a new sales manager replaces an existing sales manager, state-full content such as personal or collaborative project work, instantiated work events, and other content may be provided to the new sales manager via the workset-based portal system. State-full content can also serve as a template for creating similar worksets (e.g., for creating team rooms).

Consistent with embodiments of the invention, users may interact with worksets via one or more workspaces (e.g., portal pages or portions of portal pages) including user-interface elements. A workspace is a spatial arrangement of services and information that together support a coherent set of tasks. Each workset includes user-interface elements associated with that workset and that are displayed in the workspace for enabling tasks associated with the workset. A workspace can include a number of components, which may include integrated views (Iviews), for presenting content to the employee. A workspace may include structured information (e.g., applications) and unstructured information, may offer social experience (e.g., users may share opinions, interact with other users via a chat function, share lessons learned, and/or may determine how many users have accessed particular workspaces), and may offer direct access to related actions or information.

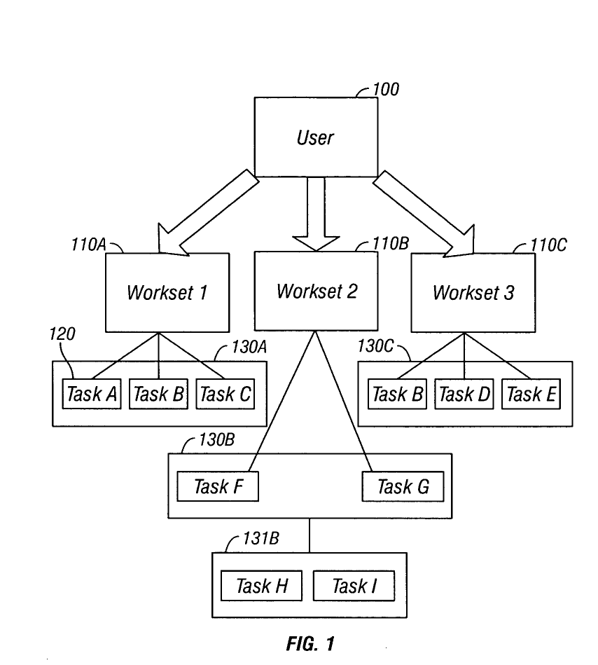

Referring now to FIG. 1, an exemplary structure is shown of a workset-based portal system, consistent with an embodiment of the invention. The embodiment of FIG. 1 illustrates the relationship between an employee's job role, assigned worksets, tasks, and workspaces. An employee or user 100 has a job role which generally describes his/her overall work responsibilities. Typical job roles include, for example, manager, engineer, developer, sales person, administrator, etc.

A plurality of worksets (e.g., worksets 110A, 110B, and 110C) can be associated with employee 100. In the embodiment of FIG. 1, worksets 110A, 110B, and 110C are associated with three different aspects of the employee's employment. These aspects can be work roles of the employee. The worksets may include one or more tasks that enable the employee to perform the work role. Workset 110A includes a number of tasks 120, such as tasks A, B, and C, which are presented to the employee on a workspace 130A. Workset 110B includes tasks F and G, which are presented to the employee on a workspace 130B. Workset 110B also includes tasks H and I, which are presented to the employee on a workspace 131B. Tasks H and I may be second-level tasks associated with first-level tasks F and/or G, or may be first-level tasks presented in workspace 131B for clarity's sake. Workset 110C includes tasks B, D, and E, which are presented to the employee on a workspace 130C. By way of a non-limiting example, workspace 130A may include one or more iViews on a portal page.

A particular component, such as a task presented on a particular iView, may be presented on more than one workspace. For example, a particular task may be relevant to two different worksets assigned to an employee. Rather than associating the task with only one workset (e.g., to avoid duplication), it may be associated with both worksets so that the employee does not have to switch among workspaces to access that particular task. Referring to FIG. 1, task B is included in both workset 110A and in workset 110C, and may be presented to the employee on both workspace 130A and workspace 130C.

The workspace may include an inventory structure such as a two-level tab structure. The inventory structure enables the employee to quickly find the desired task or service. For example, the first level tabs may provide access to generic portal pages such as a home page, as well as workspaces associated with worksets. The second level tabs may provide access to tasks and sub-tasks associated with the corresponding portal page.

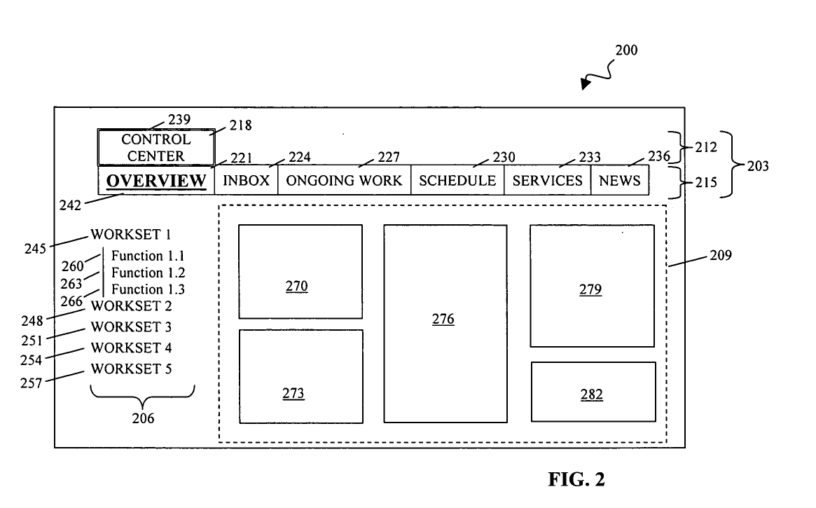

FIG. 2 illustrates an exemplary workspace portal page 200, consistent with an embodiment of the invention. Workspace portal page 200 may be provided for improving workflow by facilitating access to worksets, other portal pages, and/or associated tasks. Portal page 200 includes such an inventory structure along with other features that facilitate workflow. In particular, portal page 200 includes a tab structure 203, a workset list 206, and a data screen 209.

Tab structure 203 facilitates the representation of data relevant to a workset, and to individual tasks within a workset, to an employee. In particular, tab structure 203 includes an upper level 212 and a lower level 215. Upper level 212 identifies a collection of active worksets to an employee by providing the employee with a horizontal list of the names of active worksets. A particular workset can be denoted as active based on the amount or kind of user interaction with the workset. The horizontal list of names provides a relatively expanded view of the active worksets to an employee, facilitating selection and speeding workflow. The expanded view is provided by the spacing between workset names, along with the adjacent orientation of the names with their long axes running across portal page 200. Upper level 212 also identifies which of the active worksets is currently the source of the data represented to an employee in data screen 209. Lower level 215 identifies the tasks within the current workset, as well as the particular task within the current workset that is the source of the data represented to an employee in data screen 209.

When an employee first accesses upper level 212, upper level 212 may include a single tab, namely control center tab 218, whereas lower level 215 includes an overview tab 221, an inbox tab 224, an ongoing work tab 227, a schedule tab 230, a services tab 233, and a services tab 236. Control center tab 218 includes a double line indicator 239 that denotes that the control center workset is the current workset from which data are represented in data screen 209. Although double line indicator 239 is redundant in FIG. 2 given that control center tab 218 is the only workset indicator in upper level 212, double line indicator 239 is not redundant when additional workset indicators are present in upper level 212, as discussed further below. Overview tab 221 includes an underline indicator 242 that denotes that data regarding the employee's “overview” tasks that are currently represented in data screen 209.

In operation, an employee selects from among tabs 221, 224, 227, 230, 233, 236 in lower level 215 to interact with data regarding the different tasks associated with each of tabs 221, 224, 227, 230, 233, 236. Similarly, when more than one tab is present in upper level 212, an employee can select from among the tabs in upper level 212 to interact with data regarding different worksets. The interaction can occur in data screen 209.

As illustrated in FIG. 2, workset list 206 may include workset identifiers 245, 248, 251, 254, 257. Workset identifiers 245, 248, 251, 254, 257 can be the names of various worksets of data relevant to a particular work goal or small set of work goals. Workset list 206 can include the names of worksets in a vertical list to provide a relatively dense inventory of the worksets with tight spacing between the workset names, relatively smaller font sizes, and/or the names adjacently arranged with their short axes running down portal page 200. Workset list 206 can be an exhaustive list in that it includes all or nearly all of the worksets related to an employee's job. The presentation of an exhaustive list of worksets speeds workflow by allowing an employee easy access to all or nearly all of the worksets related to the employee's job. Although user navigation of such a dense list of worksets may be relatively slower, the presentation of such a dense inventory of worksets alongside an expanded inventory of active worksets can provide easy navigation of active worksets and an exhaustive list of worksets in a single portal page.

Workset list 206 may also include a series of task identifiers 260, 263, 266 that are associated with workset identifier 245. Task identifiers 260, 263, 266 can be the names of various tasks included in the workset identified by workset identifier 245. A user can interact with workset identifiers 245, 248, 251, 254, 257 to expand them and reveal associated tasks or contract them and conceal associated tasks.

In operation, an employee selects from among workset identifiers 245, 248, 251, 254, 257 in workset list 206 (e.g., by double clicking on the workset or by clicking on a carrot or icon associated with the selected workset identifier) to interact with data regarding the selected workset or to display or conceal tasks associated with the selected workset. Similarly, an employee selects from among task identifiers 260, 263, 266 to interact with data regarding the identified tasks. The subsequent interaction with data regarding tasks and worksets can occur in data screen 209.

Data screen 209 is a display area for representing data that includes a series of self-contained subsections 270, 273, 276, 279, 282. Subsections 270, 273, 276, 279, 282 can be dedicated to representing a portion of the data regarding tasks and worksets to an employee and for receiving user input regarding the represented data. For example, subsections 270, 273, 276, 279, 282 can provide for user interaction with executable programs, content, email, scheduling, or other elements of the employee's work activities. By way of non-limiting examples, subsections 270, 273, 276, 279, 282 can be HTML frames, portlets, or iViews.

In operation, an employee interacts with data screen 209 using any of a number of input and output devices to display or change the current state of a working process in the employee's activities. This interaction can change the representation of information on data screen 209. For example, an employee can use a pointing device such as a mouse to select an input field in one of subsections 270, 273, 276, 279, 282 and a keyboard to enter or modify a text string in the field. As another example, an employee can select a particular entry from a pull down menu, or identify that a particular spreadsheet is to be loaded from memory. Such change to the representation on data screen 209 can be referred to as changes to the state of the representation in data screen 209.

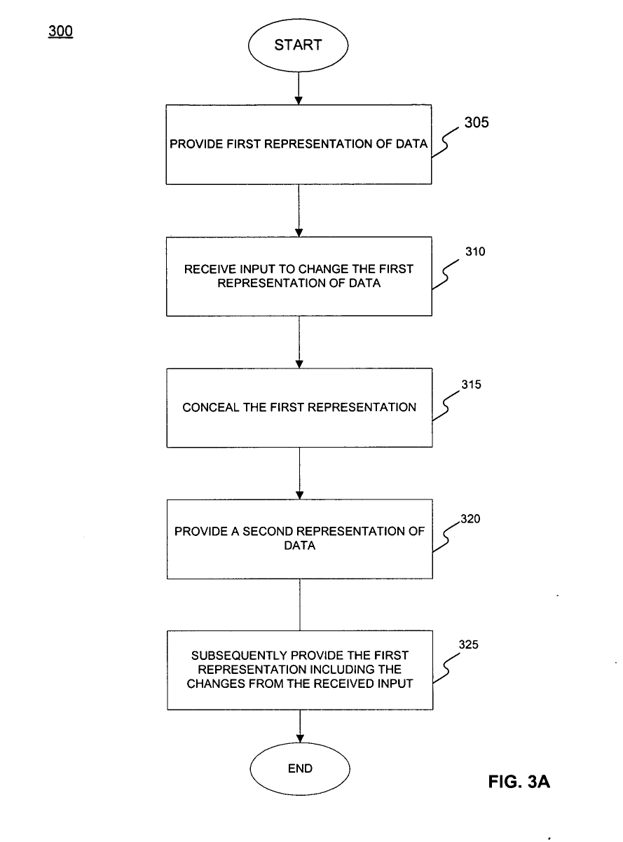

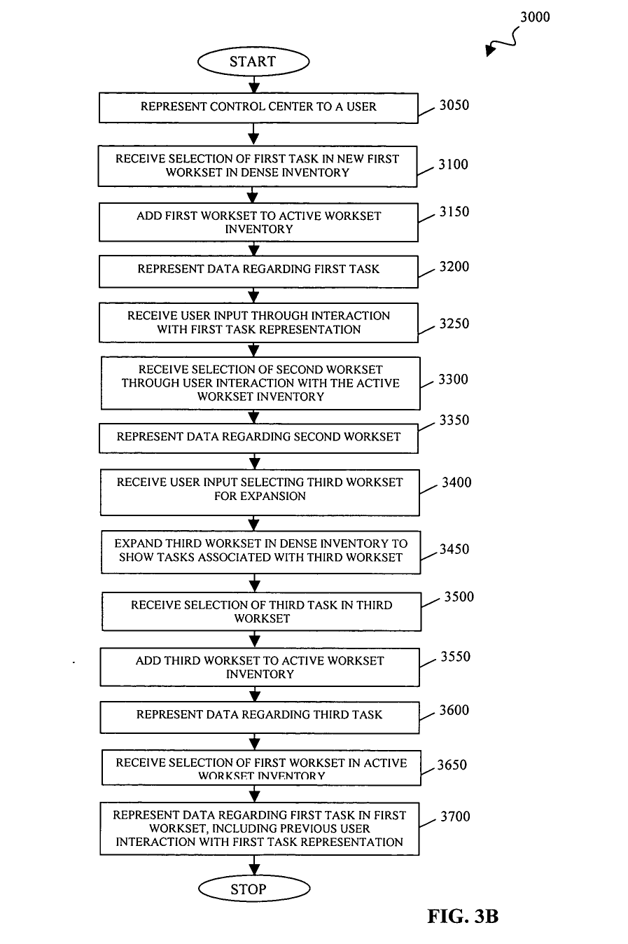

FIG. 3A is a flow chart showing an overview of an exemplary workflow 300 for a workset-based portal system, consistent with an embodiment of the invention. Workflow 300 can be performed by a computer or other data processing device that receives user input over one or more input devices and represents portal pages or other workspaces on a display panel such as a computer monitor.

Initially, a device performing workflow 300 can provide, in a portion of a portal workspace, a first representation of data relevant to a first aspect of a participant's participation in an enterprise (step 305). By way of example, the first aspect of the participant's participation in the enterprise may comprise a workset. The device may then receive input from the participant interacting with the data in the portal workspace and the participant's interaction may change the first representation (step 310). The device may conceal the first representation of data (step 315) and provide, in the portion of the portal workspace, a second representation of data (step 320).

Consistent with embodiments of the invention, providing the second presentation of data (step 320) may comprise providing the second representation of data relevant to a second aspect of the participant's participation in the enterprise. Additionally, or alternatively, providing the second presentation of data may comprise providing the second representation of data relevant to the first aspect of the participant's participation in the enterprise.

Subsequent to providing the second presentation of data (step 320), the device may provide the first representation of data including the changes resulting from the participant's prior interaction (step 325). Consistent with embodiments of the invention, the first representation of data including the changes may be provided in the same or a different portion of the portal workspace.

FIG. 3B is a flow chart showing an exemplary workflow 3000 for a workset-based portal system, consistent with another embodiment of the invention. As with workflow 300, workflow 3000 can be performed by a computer or other data processing device that receives user input over one or more input devices and represents portal pages or other workspaces on a display panel such as a computer monitor.

A device performing workflow 3000 can represent a control center to an employee user (step 3050). The control center can be a workset portal page (such as portal page 200 of FIG. 2) in that it provides a representation of information relevant to high-level control activities. The represented information can include inventories of worksets and active worksets. The inventory of worksets can be a dense inventory that exhaustively identifies a large number of worksets. The inventory of active worksets can be an expanded inventory that identifies an active subset of worksets from the dense inventory that are likely to be selected by the employee during work activities. The information represented in the control center can also include, e.g., a schedule for the employee, incoming messages for the employee, progress reports or new relating to projects involving the employee, and/or links to applications commonly accessed by the employee.

The control center may be the only active workset at certain time, such as when the employee begins work, and hence the only workset in the expanded inventory. The device performing workflow 3000 can receive a selection of a first task included in an expanded first workset in the dense inventory (step 3100). The selection can be the double click of the employee upon a task identifier.

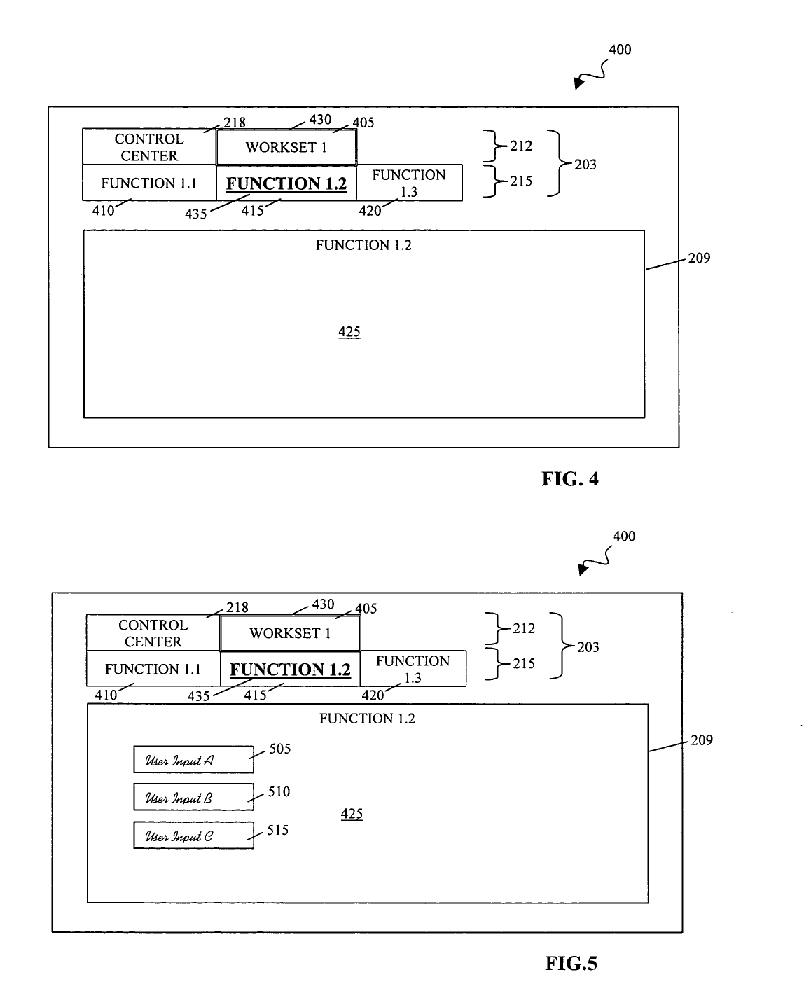

Upon receipt of the task selection, the device performing workflow 3000 can add an identifier of the first workset to the active workset inventory (step 3150) and represent data regarding the first task in a portion of the portal page (step 3200). Consistent with embodiments of the invention, FIG. 4 illustrates an exemplary portal page 400 that includes a first workset identifier 405 in upper level 212 of tab structure 203, task identifiers 410, 415, 420 in lower level 215 of tab structure 203, and representation 425 relating to selected task “Function 1.2” in data screen 209. First workset identifier 405 includes a double line indicator 430 that denotes that the first workset is the current workset from which data are represented in data screen 209. Task identifier 415 includes an underline indicator 435 that denotes that data from the selected task “Function 1.2” of the first workset are represented in data screen 209.

Returning to FIG. 3B, the device performing workflow 3000 can also receive user input through the employee's interaction with the data regarding the first task and represented in a portion of the portal page (step 3250). For example, the employee can enter text, select files for display, manipulate a pointer, or create sounds that change the representation in the portal page. As discussed before, this user interaction with the representation can be referred to as changes to the state of the representation in data screen 209 and can constitute an employee's unfinished efforts to perform the tasks and activities associated with the represented data.

Consistent with embodiments of the invention, FIG. 5 shows an exemplary portal page 400 after receipt of user input. As illustrated in FIG. 5, data screen 209 of portal page 400 may include interaction results 505, 510, 515 (such as “User Input A,” “User Input B” and “User Input C”).

Returning to FIG. 3B, the device performing workflow 3000 can also receive user input selecting a second workset through user interaction with the active workset inventory (step 3300). The active workset inventory can include the control center workset, the first workset (added in step 3150), and additional worksets added by default or based on previous user interaction with the portal page. However, for the sake of simplicity, the second workset is illustrated herein as the control center workset.

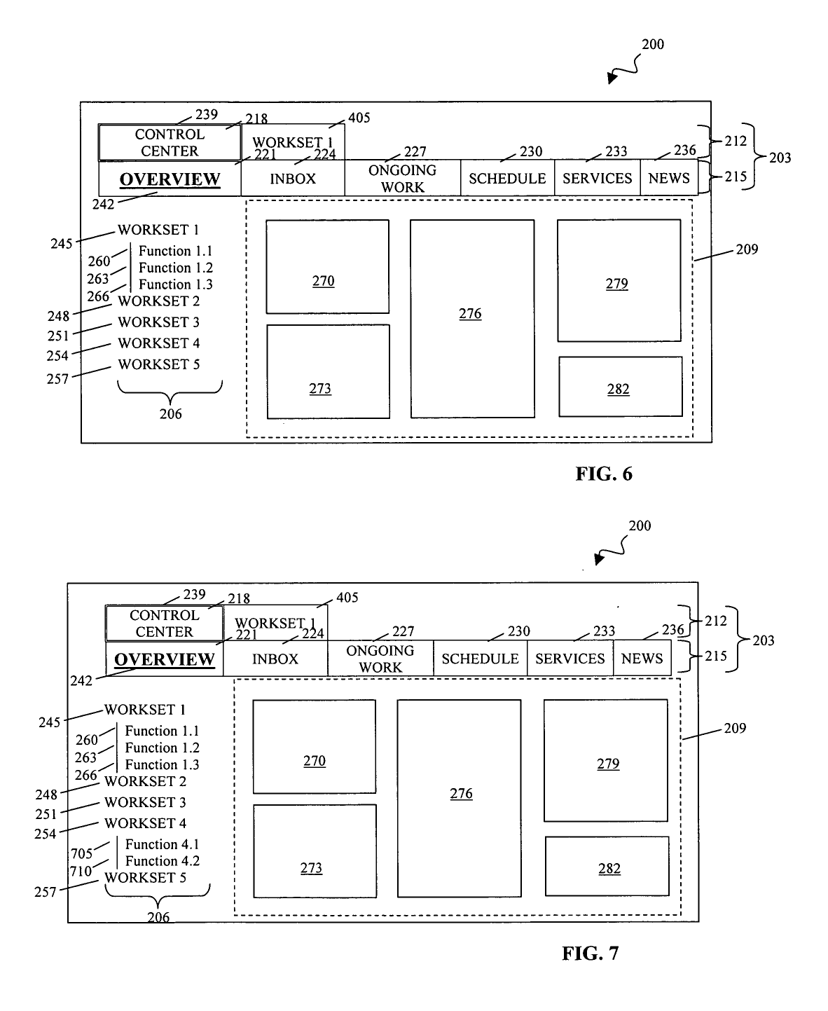

The device may then represent data regarding the selected second workset (step 3350), for example, in a data display portion of the portal page. Consistent with embodiments of the invention, FIG. 6 shows an exemplary portal page 200 representing data regarding the control center workset in data screen 209. As illustrated in FIG. 6, portal page 200 additionally includes first workset identifier 405 in upper level 212 of tab structure 203 to indicate that the first workset is now an active workset.

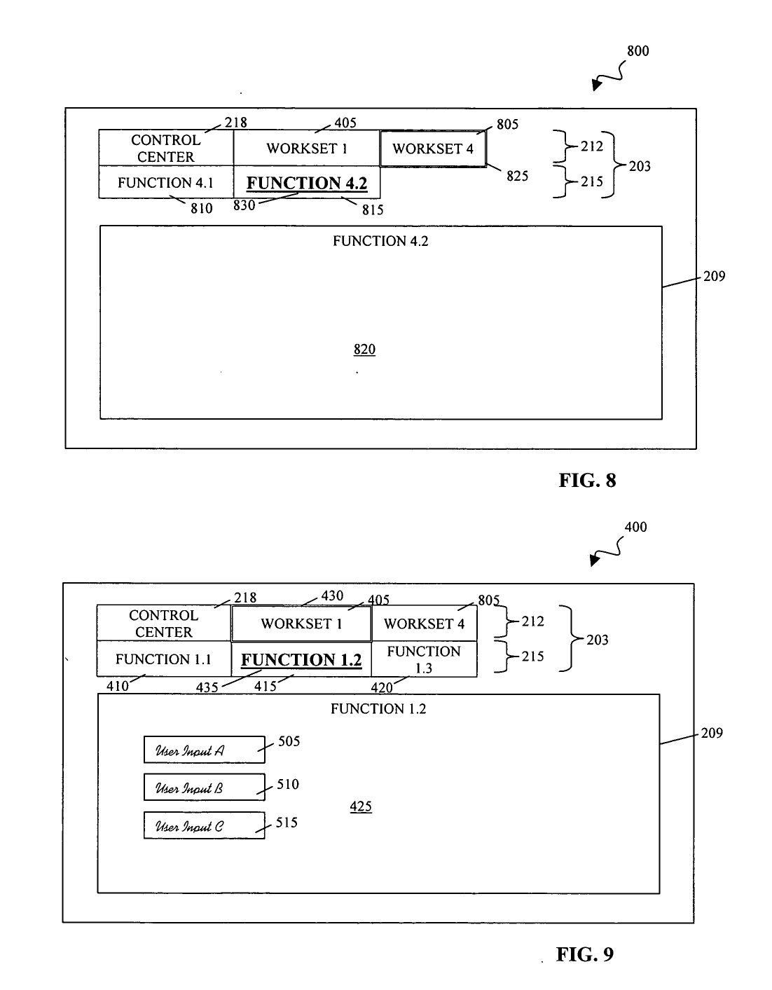

Returning again to FIG. 3B, the device performing workflow 3000 can also receive user input selecting a third workset for expansion (step 3400) and then expand the third workset in the dense inventory to reveal tasks associated with the third workset (step 3450). The employee input selecting the third workset for expansion can be a click from a pointing device on a carrot adjacent the third workset identifier or a click on the third workset identifier that creates a pull down menu of associated tasks. By way of example, FIG. 7 shows an exemplary portal page 200 including an expansion of workset 254 to include tasks 705, 710 (such as “Function 4.1” and “Function 4.2”), consistent with embodiments of the invention.

Returning to FIG. 3B, the device performing workflow 3000 can also receive a selection of a third task in the expanded third workset (step 3500). Upon receipt of the task selection, the device performing workflow 3000 can add an identifier of the third workset to the active workset inventory (step 3550) and represent data regarding the third task in a portion of the portal page (step 3600).

FIG. 8 illustrates, consistent with an embodiment of the invention, an exemplary portal page 800 that includes a third workset identifier 805 (i.e., tab “WORKSET 4”) in upper level 212 of tab structure 203, task identifiers 810, 815 in lower level 215 of tab structure 203, and representation 820 relating to selected task “Function 4.2” in data screen 209. Third workset identifier 805 includes a double line indicator 825 that denotes that the third workset is the current workset from which data are represented in data screen 209. Task identifier 815 includes an underline indicator 830 that denotes that data from the selected task “Function 4.2” of the third workset are represented in data screen 209.

Returning to FIG. 3B, the device performing workflow 3000 can also receive user selection of the first workset through user interaction with the active workset inventory (step 3650). For example, the employee can use a pointing device to target and select the first workset tab in a tab structure. The device performing workflow 3000 can represent data regarding the selected first workset in a display portion of the portal page (step 3700). The represented data can include data regarding the last task in the first workset with which the employee previously interacted. For example, the represented data can include data regarding the first task in the first workset, with which the employee previously interacted in step 3250. The represented data can include the results of previous user interaction with the data regarding the first workset, even if the interaction did not result in a change to the data regarding the first workset.

By way of example, FIG. 9 shows an exemplary portal page 400 including third workset identifier 805 in upper level 212 of tab structure 203 as well as interaction results 505, 510, 515 (such as “User Input A,” “User Input B” and “User Input C”) in data screen 209. Interaction results 505, 510, 515 are displayed despite being state-full information or services that may constitute an employee's unfinished efforts to perform the tasks and activities associated with the represented data. Further, task identifier 415 includes underline indicator 435 to denote that data from the task “Function 1.2” of the first workset are represented in data screen 209, even though previous user interaction (for example, in step 3650 of FIG. 3B) selected the first workset using workset tab 405, rather than the task “Function 1.2.” Such an automatic display of particular task data upon selection of a workset from an active workset inventory can be performed based on, e.g., the last task in the selected workset with which the employee interacted or the task in the selected workset having the most outstanding work or requiring the most immediate attention.

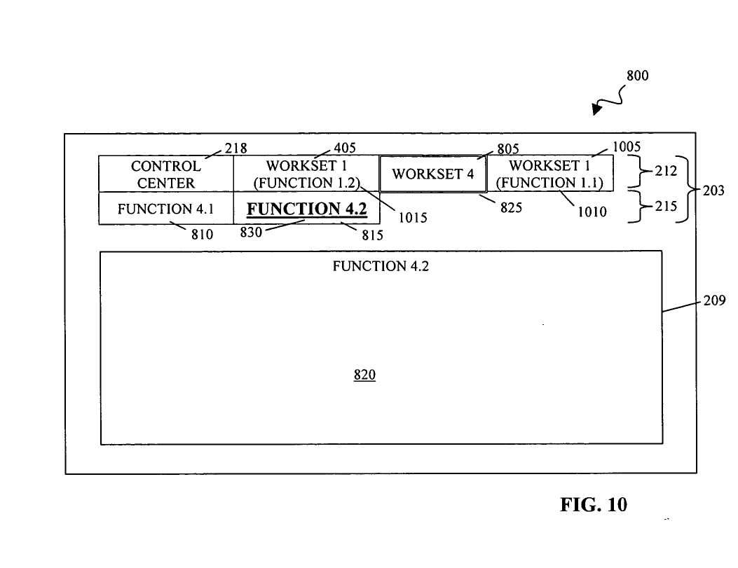

When particular task data is to be displayed upon selection of a workset from an active workset inventory, the active workset inventory can include additional information that identifies the particular task data to the employee. For example, as shown in FIG. 10, upper level 212 of tab structure 203 includes an additional first workset tab 1005. First workset tab 1005 includes a task label 1010 that denotes that data regarding the task entitled “Function 1.1” is to be represented in data screen 209 upon selection of first workset tab 1005. Similarly, first workset tab 405 includes a task label 1015 that denotes that data regarding the task entitled “Function 1.2” is to be represented in data screen 209 upon selection of first workset tab 405.

Task labels 1010, 1015 can also be omitted, relying upon the employee to identify that data regarding the task entitled “Function 1.1” is to be represented upon selection of first workset tab 1005 and that data regarding the task entitled “Function 1.2” is to be represented upon selection of first workset tab 405.

Inventories of active worksets can be saved and used to generate workset portals at a later date. For example, if an employee is to repetitively perform an established series of activities requiring the same worksets, the employee can save the inventory of active portals to quickly recreate an efficient portal workset environment.

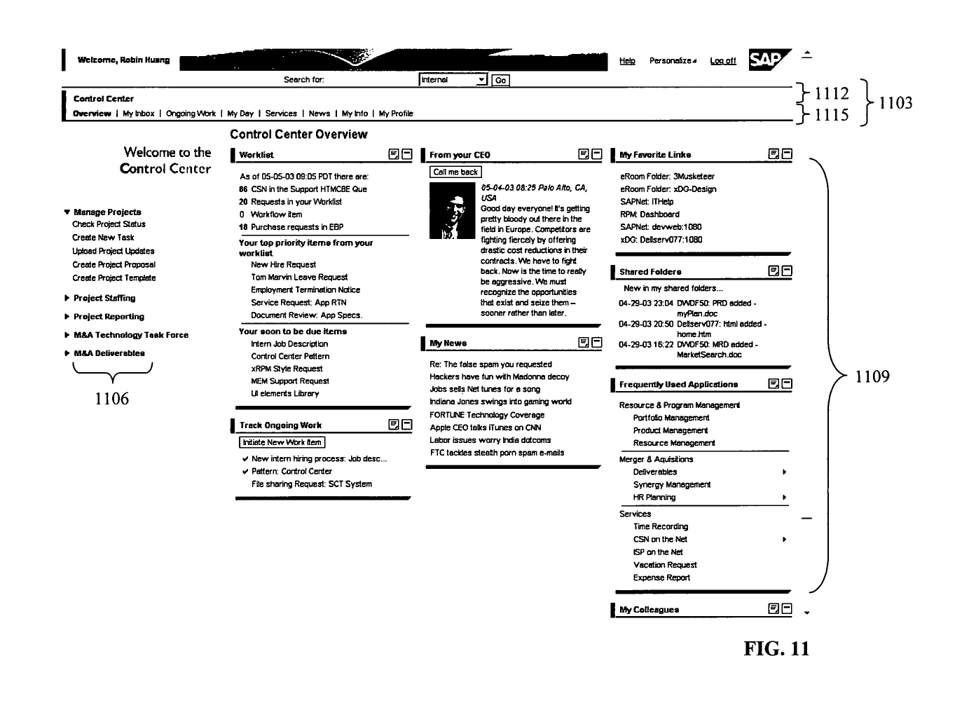

FIG. 11 shows another example of a portal page representing data regarding a control center workset. For example, the exemplary workspace portal page facilitates access to worksets, other portal pages, and/or associated tasks and includes a tab structure 1103, a workset list 1106, and a data screen 1109. Tab structure 1103 includes an upper level 1112 and a lower level 1115. Upper level 1112 may include one or more tabs (not shown in FIG. 11). These tabs may include, for example, Project Management, Resource Management, and M&A Tech Task Force tabs. Upper level 1112 represents a categorization of functionality and information that constitutes a workset. Lower level 1115 may also include tabs, such as My Inbox, Ongoing Work, My Day, Services, News, My Info, and My Profile. These tabs, when selected, allow an employee to interact with data corresponding to the tasks associated with each task, as shown on data screen 1109.

As also illustrated in FIG. 11, workset list 1106 includes workset identifiers for various worksets of data relevant to a particular work goal or smaller set of work goals. For example, FIG. 11 shows a category labeled Manage Projects, which includes task identifiers labeled Check Project Status, Create New Task, Upload Project Updates, Create Project Updates, Create Project Proposal, and Create Project Template. Other categories shown include Project Staffing, Project Reporting, M&A Technology Task Force, and M&A Deliverables. An employee may select Create Project Proposal, for example, to create a new project.

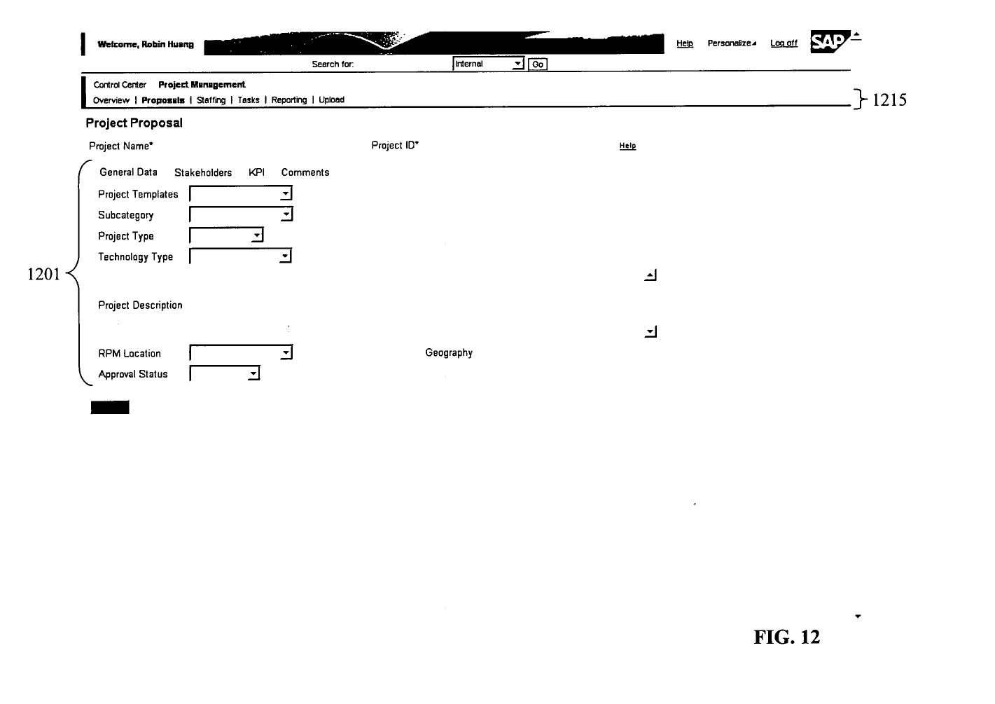

FIG. 12 shows another example portal page after step 3200 of FIG. 3B. As show in FIG. 12, when an employee makes a selection to create a new project, a project proposal form 1201 is displayed. Project proposal form 1201 includes fields for an employee to enter information to describe the project proposal. For example, an employee may make selections from pull-down menus to describe the project proposal. After completing the project proposal, the employee may return to the control center by selecting Overview from the lowever level 1215.

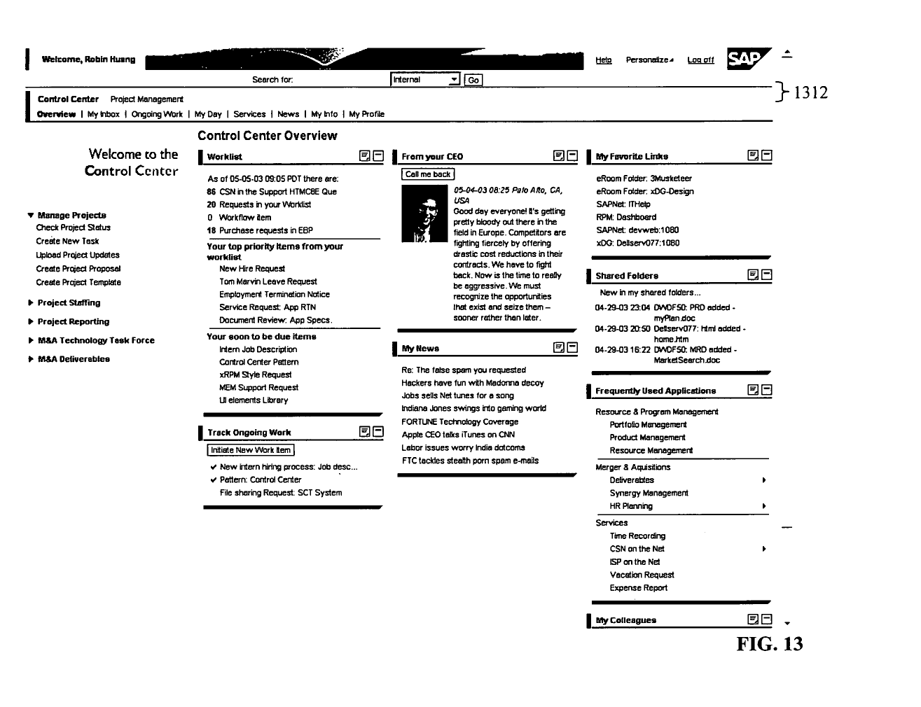

FIG. 13 shows the exemplary portal page of FIG. 11 after step 3350 of FIG. 3B. By selecting Project Management from upper level 1312, an employee may return to the project management workset. Once an employee has returned to the project management workset, the employee may continue work or may start work on a new workset.

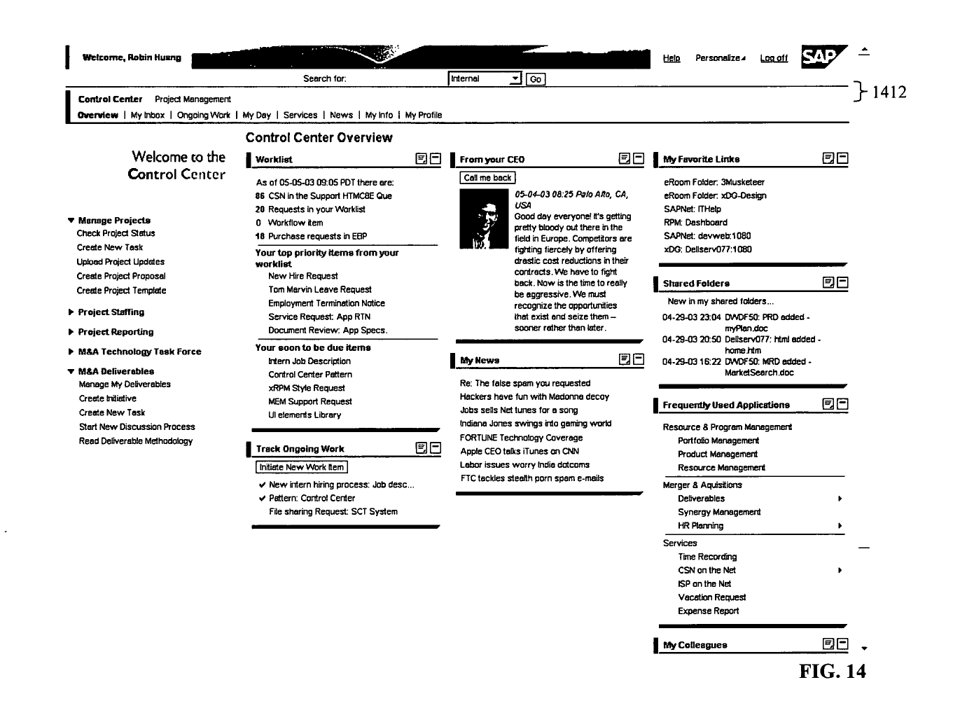

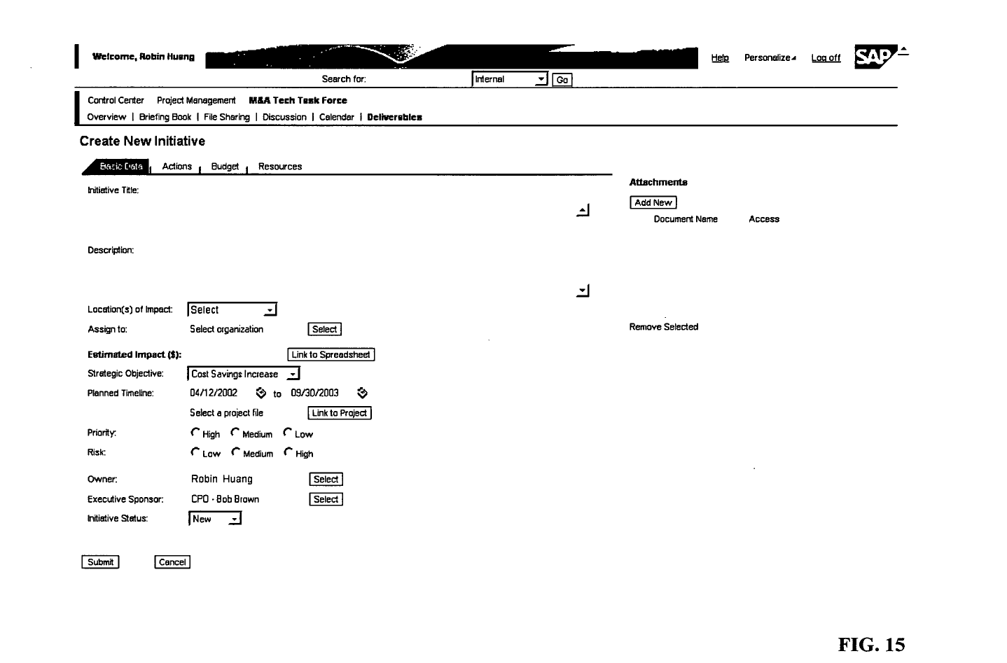

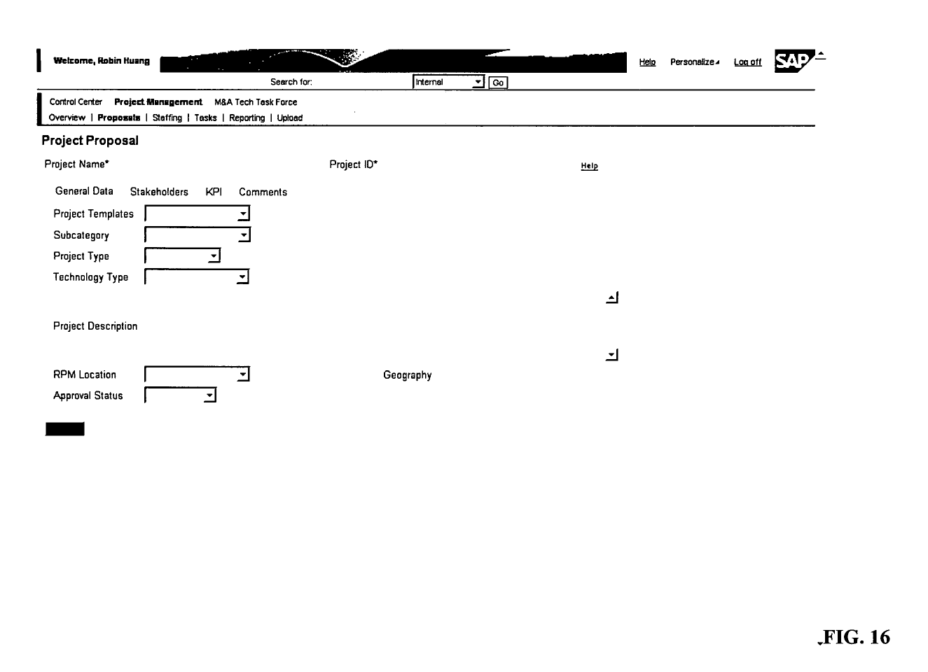

FIG. 14 shows the exemplary portal page of FIG. 11 after step 3450 of FIG. 3B. As shown in FIG. 14, only the current workset, Project Management, is shown in upper level 1412. In FIG. 15, another example portal page is shown after step 3600 of FIG. 3B. As shown in FIG. 15, an employee has selected Create New Initiative. To create a new initiative, a employee may specify various criteria by selecting from pull-down menus. Finally, FIG. 16 shows the exemplary portal page of FIG. 11 after step 3700 of FIG. 3B.

In other embodiments consistent with the principles of the present invention, workset tabs may be generated as needed to correspond to various worksets to allow an unlimited number of worksets that are available to an individual. Typically, a user is likely to only need a small number of worksets that the user is working with at a given time, thereby facilitating a compact interface. Consequentially, worksets that a user does not need can be closed at will. In addition, once a user has saved a current set of worksets, the user is able to restore specific configurations when needed, thus saving time when a transaction requires multiple screens of data.

Various implementations of the described systems and techniques can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with an employee, the systems and techniques described here can be implemented on a computer having a display device (e.g., a CRT (cathode ray tube) or LCD (liquid crystal display) monitor) for displaying information to the employee and a keyboard and a pointing device (e.g., a mouse or a trackball) by which the employee can provide input to the computer. Other kinds of devices can be used to provide for interaction with an employee as well; for example, feedback provided to the employee can be any form of sensory feedback (e.g., visual feedback, auditory feedback, or tactile feedback); and input from the employee can be received in any form, including acoustic, speech, or tactile input.

The described systems and techniques can be implemented in a computing system that includes a back-end component (e.g., a data server), a middleware component (e.g., an application server), and a front-end component (e.g., a client computer having a graphical user interface or a Web browser through which an employee can interact with an implementation of the systems and techniques described herein), or any combination of such back-end, middleware, or front-end components. The components of the system can be interconnected by any form or medium of digital data communication (e.g., a communication network). Examples of communication networks include a local area network (“LAN”), a wide area network (“WAN”), a personal area network (“PAN”), a mobile communication network, and/or the Internet.

The computing system can include clients and servers. A client and server are generally remote from each other and typically interact through a communication network. The relationship of client and server arises by virtue of computer programs running on the respective computers and having a client-server relationship to each other.

Although embodiments have been described in detail above, other modifications are possible. For example, although the discussion above centers around business enterprises, the described systems and techniques can be used in other enterprises such as non-profit environments, educational institutions, and associations. A page can be all or a portion of a display screen. The logic flows do not require the particular orders shown, or sequential orders, to achieve desirable results. In certain implementations, multitasking and parallel processing may be preferable. Hence, other implementations may be within the scope of the following claims.

It is intended, therefore, that the specification and examples be considered as exemplary only, with a true scope and spirit of the invention being indicated by the following claims and their full scope of equivalents.

1. A method comprising:
providing, in a portion of a portal workspace, a first representation of data relevant to a first aspect of a participant's participation in an enterprise;
receiving input from the participant in the form of the participant interacting with the data, the participant's interaction changing the first representation;
concealing the first representation;
providing, in the portion of the portal workspace, a second representation of data; and
providing, subsequently in the portion of the portal workspace, the first representation including the changes from the participant's interaction.

2. The method of claim 1, wherein providing the second representation of data comprises providing the second representation of data relevant to a second aspect of the participant's participation in the enterprise.

3. The method of claim 1, wherein providing the second representation of data comprises providing the second representation of data relevant to the first aspect of the participant's participation in the enterprise.

4. The method of claim 1, wherein the first aspect of the participant's participation in the enterprise comprises a workset.

5. The method of claim 1, further comprising receiving input from the participant selecting the second aspect of the participant's participation in the enterprise.

6. A method comprising:
providing a dense inventory of a collection of worksets to a participant in an enterprise, each workset including data relevant to an aspect of the participant's participation in the enterprise;
receiving input from the participant selecting a first workset from the collection to be made active;
receiving input from the participant selecting a second workset from the collection to be made active; and
providing an expanded inventory including the first and second worksets, the first and second worksets each selectable from the expanded inventory to allow the participant to interact with the data relevant to that aspect of the participant's participation in the enterprise.

7. The method of claim 6, wherein providing the dense inventory of the collection of worksets comprises providing a vertical list of names of worksets in the collection.

8. The method of claim 6, wherein providing the expanded inventory comprises providing a horizontal list of names of worksets in the collection.

9. The method of claim 6, wherein providing the expanded inventory comprises providing the expanded inventory on a same workspace as the dense inventory.

10. The method of claim 6, further comprising:
receiving input from the participant again selecting the first workset from the collection; and
adding a second selectable entry to the expanded inventory, the second selectable entry also identifying the first workset.

11. The method of claim 6, further comprising storing a description of the expanded inventory.

12. The method of claim 11, further comprising subsequently recreating the expanded inventory in a portion of a portal environment.

13. The method of claim 6, wherein providing the dense inventory of the collection of worksets comprises providing an exhaustive list of the collection of worksets.

14. A data object comprising:
an inventory of selected worksets, the worksets selected from a larger inventory of worksets based on a particular interaction by the participant with a portal environment during participation in the enterprise, the worksets each including data relevant to a particular activity in the participant's participation in an enterprise.

15. The data object of claim 14, wherein the inventory of selected worksets comprises two entries for a same single workset.

16. A system comprising:
a portal workspace, wherein a portion of the portal workspace includes a first representation of data relevant to a first aspect of a participant's participation in an enterprise;
means for receiving input from the participant interacting with the data;
means for changing the first representation based upon the participant's interaction;
means for concealing the first representation;
means for providing a second representation of data in the portion of the portal workspace; and
means for providing, subsequently in the portion of the portal workspace, the first representation including the changes from the participant's interaction.

17. The system of claim 16, wherein the means for providing the second representation of data comprises means for providing the second representation of data relevant to a second aspect of the participant's participation in the enterprise.

18. The system of claim 16, wherein the means for providing the second representation of data comprises means for providing the second representation of data relevant to the first aspect of the participant's participation in the enterprise.

19. The system of claim 16, wherein the first representation of data relevant to the participant's participation in the enterprise comprises a workset.

20. The system of claim 16, further comprises means for receiving input from the participant selecting the second aspect of the participant's participation in the enterprise.

21. A system comprising:
a dense inventory of a collection of worksets for a participant in an enterprise, wherein each workset includes data relevant to an aspect of the participant's participation in the enterprise;
means for receiving input from the participant selecting a first workset from the collection to be made active;
means for receiving input from the participant selecting a second workset from the collection to be made active; and
means for providing an expanded inventory including the first and second worksets, wherein the first and second worksets are each selectable from the expanded inventory to allow the participant to interact with the data relevant to that aspect of the participant's participation in the enterprise.

22. The system of claim 21, wherein the dense inventory of the collection of worksets comprises a vertical list of names of worksets in the collection.

23. The system of claim 21, wherein the means for providing the expanded inventory comprises a horizontal list of names of worksets in the collection.

24. The system of claim 21, wherein means for providing the expanded inventory comprises means for providing the expanded inventory on a same workspace as the dense inventory.

25. The system of claim 21, further comprising:
means for receiving input from the participant again selecting the first workset from the collection; and
means for adding a second selectable entry to the expanded inventory, wherein the second selectable entry also identifying the first workset.

26. The system of claim 21, further comprising means for storing a description of the expanded inventory.

27. The system of claim 26, further comprising means for subsequently recreating the expanded inventory in a portion of a portal environment.

28. The system of claim 21, wherein the dense inventory of the collection of worksets comprises an exhaustive list of the collection of worksets.
